(19) United States
(12) Patent Application Publication
(10) Pub. No.: US 2019/0079311 A1
(43) Pub. Date: Mar. 14, 2019

(54) EYEGLASSES ASSEMBLY STRUCTURE

(71) Applicant: HSIEN CHANG OPTICAL INDUSTRIAL CO., LTD., TAINAN (TW)

(72) Inventor: WEN-HSIUNG CHOU, TAINAN (TW)

(21) Appl. No.: 15/699,167

(22) Filed: Sep. 8, 2017

(51) Int. Cl. G02C 1/08

(52) U.S. Cl. CPC G02C 1/08; G02C 2200/06; G02C 2200/08

(57) ABSTRACT

An eyeglasses assembly structure is disclosed herein. It comprises an upper frame having a first connecting part having a receiving slot and a receiving hole, two upper lens assembly portions disposed on two sides of the first connecting part, and two upper connecting parts disposed at two lateral ends thereof, each of the two upper connecting parts having an engaging hole; and a lower frame having a second connecting part in a middle thereof having an inserting block and an engaging member for respectively and correspondingly engaging with the receiving slot and the receiving hole, two lower lens assembly portion disposed on two sides of the second connecting part, and two lower connecting parts disposed at two lateral ends thereof and corresponding to the two upper connecting parts, each of the two lower connecting parts having a protrusion for correspondingly inserting into the engaging hole.

### BACKGROUND OF THE INVENTION

### 1. Field of the Invention

The present invention relates to provide an eyeglasses assembly structure which can assemble to lenses or disassemble from lenses easily without the need of other tools and has trendy and changeable appearance to meet the demands for fashion and variation so that the present invention has increased competitiveness in the market and increased practical features of overall implementation.

### 2. Description of Related Art

Generally, various eyeglasses can be classified according to different specific purposes and functions, e.g. myopia glasses, presbyopic glasses, sunglasses for protect the eyes from sunshine or for matching the dress up, and safety glasses for eye protection during work. No matter what kind of eyeglasses, it mainly comprises a frame, lenses disposed and fixed in the frame, and a pair of temples screwed to two sides of the frame so that a user can wear the eyeglasses by the pair of temples.

Although all kinds of conventional eyeglasses mentioned above can achieve their intended effects, they still have many disadvantages in the actual operation of use:

1. The conventional eyeglasses require screw components and other tools for assembling the lenses to the frames, so the lenses and the frames cannot be attached to or detached from each other easily and have restrictions on the overall structural design that needs to be improved.

2. The frames of the conventional eyeglasses are usually formed integrally so that the color or appearance of the frames cannot be changed, resulting in a monotonous overall appearance of the conventional eyeglasses and losing the product competitiveness in the market.

### SUMMARY OF THE INVENTION

In view of the above-mentioned problems, the object of the present invention is to provide an eyeglasses assembly structure which comprises an upper frame, and a lower frame engaged with the upper frame for further engaging with lenses. Accordingly, the upper frame and the lower frame of the present invention can be assembled or disassembled from each other without the need of other tools, and the lenses can be assembled between the upper frame and the lower frame easily. Furthermore, the overall appearance of the eyeglasses assembly structure can be altered by changing different colors of the upper frame and the lower frame to meet the demands for fashion and variation so that the present invention has increased competitiveness in the market and increased practical features in use.

Disclosed herein is an eyeglasses assembly structure. It mainly comprises an upper frame and a lower frame. The upper frame has a first connecting part in a middle thereof, two upper lens assembly portions disposed on two sides of the first connecting part, and two upper connecting parts disposed at two lateral ends thereof. The first connecting part is provided with a receiving slot at a bottom thereof and a receiving hole at an inner face thereof for communicating with the receiving slot, and each of the two upper connecting parts is provided with an engaging hole.

The lower frame having a second connecting part in a middle thereof and corresponding to the first connecting part of the upper frame, two lower lens assembly portion disposed on two sides of the second connecting part, and two lower connecting parts disposed at two lateral ends thereof and corresponding to the two upper connecting parts of the upper frame. The second connecting part is provided with an inserting block and an engaging member for respectively and correspondingly engaging with the receiving slot and the receiving hole of the first connecting part, and each of the two lower connecting parts is provided with a protrusion for correspondingly inserting into the engaging hole of each of the two upper connecting parts.

According to an embodiment of the present invention, each of the two upper connecting parts is provided with an upper bonding part on a lower edge thereof, and each of the two lower connecting parts is provided with a lower bonding part for correspondingly engaging with the upper bonding part of each of the two upper connecting parts.

### BRIEF DESCRIPTION OF THE DRAWINGS

FIG. 1 is an exploded diagram showing an eyeglasses assembly structure according to the present invention;

FIG. 2 is a partial lateral view showing an eyeglasses assembly structure according to the present invention;

FIG. 3 is a partial enlarged view showing a protrusion of a lower connecting part is correspondingly inserted into an engaging hole of an upper connecting part;

FIG. 4 is a partial lateral view showing a receiving slot and a receiving hole of a first connecting part are engaged with an inserting block and an engaging member of a second connecting part;

FIG. 5 is a cross-sectional diagram showing a protrusion of a lower connecting part is correspondingly engaged with an engaging hole of an upper connecting part.

### DETAILED DESCRIPTION OF THE PREFERRED EMBODIMENT

Hereinafter, an exemplary embodiment of the present invention will be described in detail with reference to the accompanying drawings.

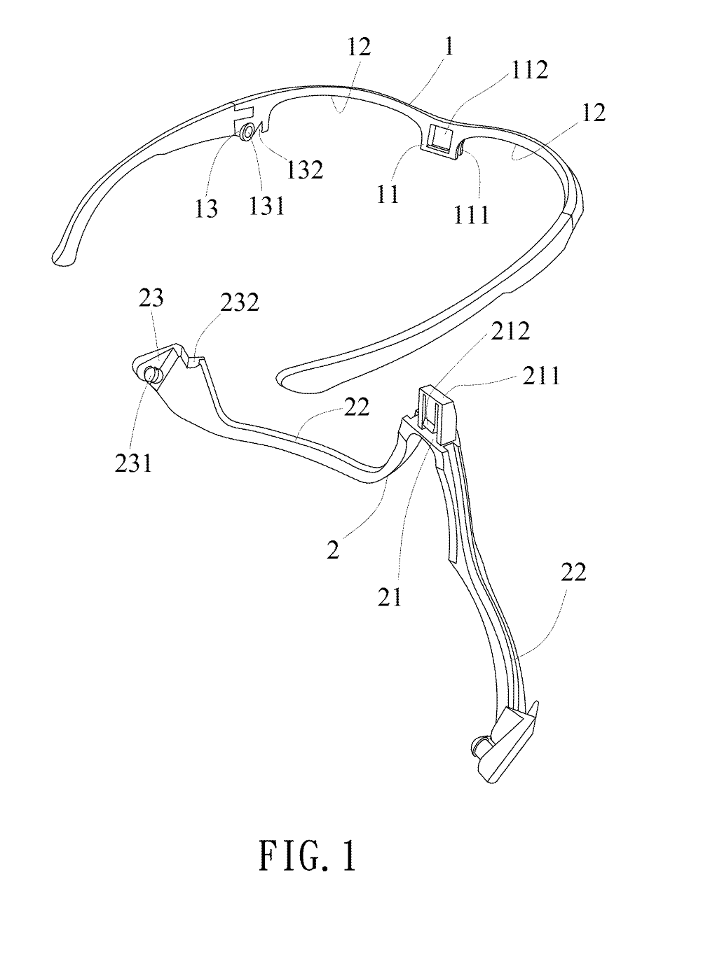

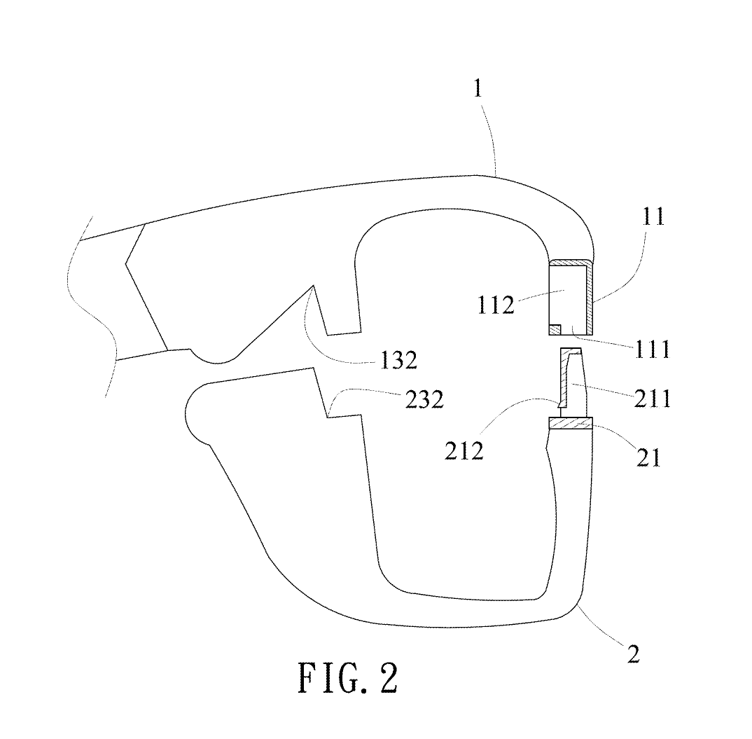

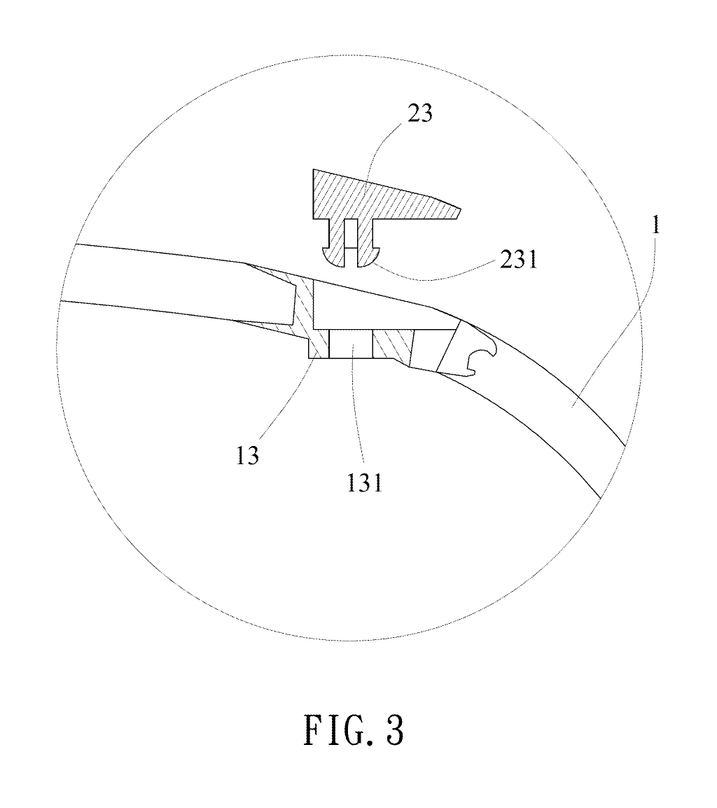

As showed in FIG. 1, FIG. 2 and FIG. 3, an exploded diagram showing an eyeglasses assembly structure, a partial lateral view showing an eyeglasses assembly structure, and a partial enlarged view showing a protrusion of a lower connecting part is correspondingly inserted into an engaging hole of an upper connecting part are respectively disclosed.

The eyeglasses assembly structure of the present invention mainly comprises an upper frame (1) and a lower frame (2).

The upper frame (1) has a first connecting part (11) in a middle thereof. The first connecting part (11) is provided with a receiving slot (111) at a bottom thereof and a receiving hole (112) at an inner face thereof for communicating with the receiving slot (111) Moreover, the upper frame (1) further has two upper lens assembly portions (12) disposed on two sides of the first connecting part (11) and two upper connecting parts (13) disposed at two lateral ends thereof Each of the two upper connecting parts (13) is provided with an engaging hole (131) and an upper bonding part (132) on a lower edge thereof.

The lower frame (2) has a second connecting part (21) in a middle thereof and corresponding to the first connecting part (11) of the upper frame (1). The second connecting part (21) is provided with an inserting block (211) corresponding to the receiving slot (111) of the first connecting part (11) and an engaging member (212) in a middle of the inserting block (211) and corresponding to the receiving hole (112) of the first connecting part (11). Moreover, the lower frame (2) further has two lower lens assembly portions (22) disposed on two sides of the second connecting part (21) and two lower connecting parts (23) disposed at two lateral ends thereof and corresponding to the two upper connecting parts (13) of the upper frame (1). Each of the two lower connecting parts (23) is provided with a protrusion (231) for correspondingly inserting into the engaging hole (131) of each of the two upper connecting parts (13) and a lower bonding part (232) for correspondingly engaging with the upper bonding part (132) of each of the two upper connecting parts (13).

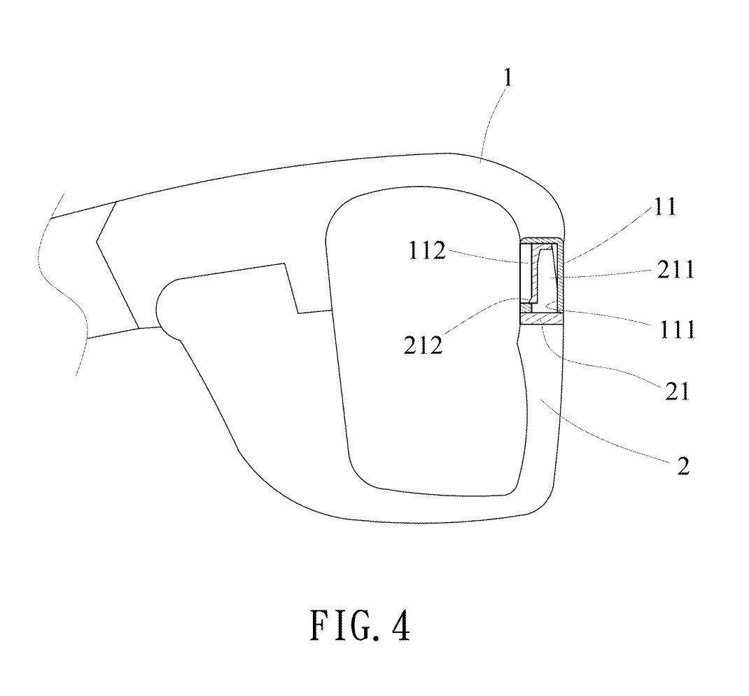

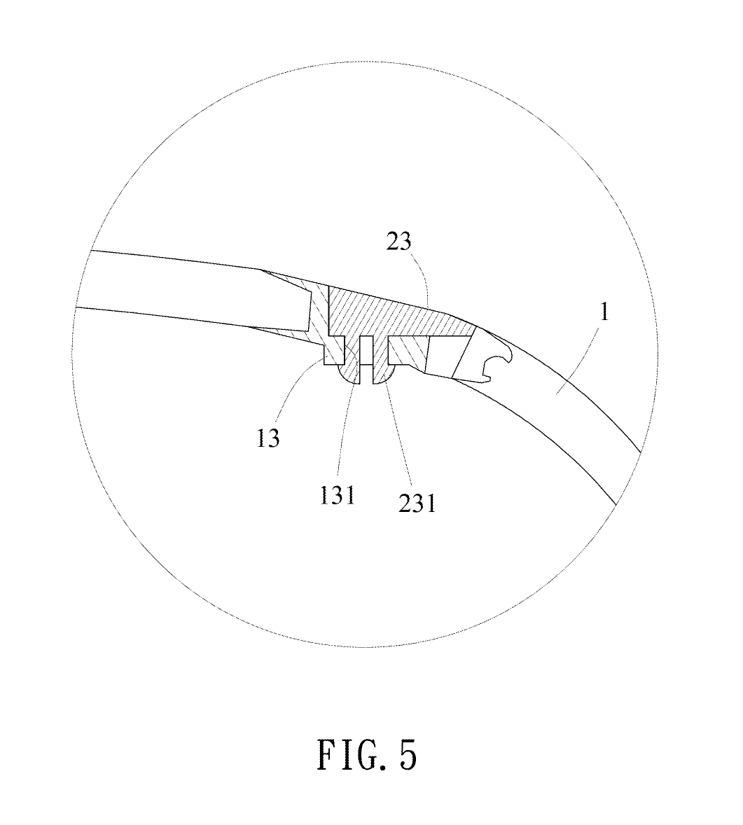

Accordingly, in assembling the present invention, the lower frame (2) is correspondingly disposed below the upper frame (1) by inserting the second connecting part (21) of the lower frame (2) into the first connecting part (11) of the upper frame (1) and inserting the inserting block (211) of the second connecting part (21) into the receiving slot (111) of the first connecting part (11). In such a case, the engaging member (212) in the middle of the inserting block (211) is correspondingly engaged with the receiving hole (112) of the first connecting part (11) as shown in FIG. 4. Furthermore, as shown in FIG. 5, the two lower connecting parts (23) of the lower frame (2) corresponding to the two upper connecting parts (13) of the upper frame (1) allows the protrusions (231) of the two lower connecting parts (23) to insert into the engaging holes (131) of the two upper connecting parts (13) and allows the lower bonding parts (232) of the of the two lower connecting parts (23) to insert into the upper bonding parts (132) of the two upper connecting parts (13) so that the upper frame (1) can be firmly bonded to the lower frame (2) and then the lenses can be assembled between the two upper lens assembly portions (12) of the upper frame (1) to and the two lower lens assembly portions (22) of the lower frame (2) easily.

Compared with the technique available now, the present invention has the following advantages:

1. The upper frame and the lower frame of the present invention can be assembled by engagement and disassembled from each other without the need of other tools and the lenses can be assembled between the upper frame and the lower frame easily, so the present invention has increased practical features of overall implementation in use.

2. The overall appearance of the eyeglasses assembly structure can be altered by changing different colors of the upper frame and the lower frame to meet the demands for fashion and variation so that the present invention has increased competitiveness in the market.

1. An eyeglasses assembly structure, comprising:
an upper frame having a first connecting part at a middle thereof, two upper lens assembly portions disposed at two sides of the first connecting part, and two upper connecting parts disposed laterally apart at respective ends of the upper lens assembly portions, wherein the first connecting part is provided with a receiving slot at a bottom thereof and a receiving hole at an inner face communicating with the receiving slot, and wherein each of the two upper connecting parts is provided with an engaging hole; and
a lower frame detachably coupled to the upper frame to capture one or more lenses therebetween, the lower fame having a second connecting part at a middle thereof corresponding to the first connecting part, two lower lens assembly portions disposed at two sides of the second connecting part, and two lower connecting parts disposed laterally apart at respective ends of the lower lens assembly portions and corresponding to the two upper connecting parts, wherein the second connecting part is provided with an inserting block and an engaging member for respectively and correspondingly engaging with the receiving slot and the receiving hole, and wherein each of the two lower connecting parts is provided with a protrusion inserting laterally into the engaging hole of one of the two upper connecting parts to releasably lock the lower connecting part thereto.

2. The eyeglasses assembly structure as claimed in claim 1, wherein each of the two upper connecting parts is provided with an upper bonding part on a lower edge thereof, and each of the two lower connecting parts is provided with a lower bonding part for correspondingly engaging with the upper bonding part of one of the two upper connecting parts.
